(19) United States
(12) Patent Application Publication
(10) Pub. No.: US 2020/0228311 A1
(43) Pub. Date: Jul. 16, 2020

(54) LIGHTWEIGHT ENCRYPTION, AUTHENTICATION, AND VERIFICATION OF DATA MOVING TO AND FROM INTELLIGENT DEVICES

(71) Applicant: Syccure Inc., Armonk, NY (US)

(72) Inventor: Thomas Capola, Armonk, NY (US)

(21) Appl. No.: 16/736,158

(22) Filed: Jan. 7, 2020

Related U.S. Application Data
(60) Provisional application No. 62/790,891, filed on Jan. 10, 2019.

(51) Int. Cl. H04L 9/06; H04L 9/08; H04L 9/32

(52) U.S. Cl. CPC H04L 9/065; H04L 9/0643; H04L 9/3242; H04L 9/083; H04L 9/0825

(57) ABSTRACT

An endpoint device includes a processing device to generate a dynamic salt via combination of a secret, shared with a second endpoint device, with profile information associated with the endpoint device. The device further generates a digest via a hash, using the dynamic salt, of a previous message sent to the second endpoint device, and calculates parity information associated with the plaintext data. The device is further to generate, using a stream cipher, ciphertext data (that is verifiable by the second endpoint device) via encryption of a combination of the plaintext data, the parity information, and the digest. A communication interface is coupled to the processing device, wherein the communication interface is adapted to transmit the ciphertext data to the second endpoint device.

### REFERENCE TO EARLIER FILED APPLICATION

This application claims benefit under 35 U.S. C. § 119(e) of U.S. Provisional Patent Application No. 62/790,891, filed Jan. 10, 2019, entitled “Internet-of-Things (IoT) Device Lightweight Encryption, Authentication, and Verification of Data,” which is incorporated herein by this reference in its entirety.

### TECHNICAL FIELD

The disclosure relates to network security of communication devices, and more particularly, to lightweight encryption, authentication, and verification of data moving to and from intelligent devices.

### BACKGROUND

Modern computer networks continue to expand as thousands of intelligent devices, including internet-of-things (IoT) devices, are added so as to be able to draw data from these devices and to control these devices in an increasingly automated world. The price of this growth is an ever-increasing security challenge of authenticating and authorizing so many devices, some of which are older or “legacy” devices where others are built on modern technology. No system or method exists for encrypting, verifying, and authenticating data using a primarily a cryptographic hash function.

### BRIEF DESCRIPTION OF THE DRAWINGS

FIG. 1 is a block diagram of a distributed system of a sending endpoint device and a receiving endpoint device according to an embodiment.

FIG. 2A is a data flow diagram that illustrates a cryptographic process for preparing a plaintext for encrypted transmission in which the plaintext can be verified as non-repudiable and be authenticated as originating from the sender according to some embodiment.

FIG. 2B is a data flow diagram that illustrates a cryptographic process for decrypting the cipher-text generated in FIG. 2A for encrypted transmission where the plaintext can be verified as non-repudiable and be authenticated as originating from the sender according to some embodiments.

FIG. 3A is a flow chart of a method corresponding to the flow diagram of FIG. 2A according to an embodiment.

FIG. 3B is a flow chart of a method corresponding to the flow diagram of FIG. 2B according to an embodiment.

FIG. 4A is a data flow diagram that illustrates another cryptographic process for encrypting plaintext that combines public key infrastructure (PKI) with a method for authentication and verification according to some embodiment.

FIG. 4B illustrates a data flow diagram that illustrates another cryptographic process for decrypting plaintext generated in FIG. 4A that combines public key infrastructure (PKI) with a method for authentication and verification according to some embodiments.

FIG. 5A is a flow chart of a method corresponding to the flow diagram of FIG. 4A according to an embodiment.

FIG. 5B is a flow chart of a method corresponding to the flow diagram of FIG. 5A according to an embodiment.

FIG. 6 is a network architecture diagram that illustrates various computing endpoints communicating with a server using shared secrets according to various embodiments.

FIG. 7 is a data flow diagram that illustrates a process of composing a salt for a cryptographic hash function using components from the sending devices hardware, software, previous message, and shared secrets according to various embodiments.

FIG. 8A is a deployment diagram for an endpoint device according to an embodiment.

FIG. 8B illustrates a deployment diagram for a server that manages endpoint devices and out-of-bound (OOB) communications according to some embodiments.

FIG. 9 is a block diagram for a computing system according to various embodiments of the communication devices disclosed herein.

### DETAILED DESCRIPTION

The present application is related to the encryption, authentication, and verification of data sent to and received from intelligent devices over one or more network, to include the internet, using primarily hash-based cryptographic methods. Intelligent devices may be understood to refer to Internet of Things (IoT) devices. The IoT is a system of interrelated computing devices, mechanical and digital machines, objects, animals or people that are provided with unique identifiers (UIDs) and the ability to transfer data over a network without requiring human-to-human or human-to-computer interaction.

The ever-increasing number of IoT devices in homes and organizations creates an increased attack surface that is targeted by criminals and remains vulnerable due to inadequate security surrounding transferred data. At risk is not only the data generated by IoT devices, but any data passed within a network over which an unsecure IoT device communicates. High bandwidth, direct connections to the internet via 5G, for example (and future generations), will increase the threat of Mirai-like botnets. Mirai is a malware that turns networked devices running Linux® into remotely controlled bots that can be used as part of a botnet in large-scale network attacks. These direct connections will also provide attackers the ability to bypass perimeter protections that are normally in place in homes and organizations.

Accordingly, the cybersecurity world is attuned to these issues and working to generate solutions. The present disclosure resolves these issues in a multi-faceted way in providing encryption, authentication, and verification of data sent by or received from an intelligent device, which will generally be referred to herein as an endpoint device.

In one embodiment, a sending endpoint device includes a processing device coupled to a communication interface. The processing device may generate a dynamic salt via combination of a secret, shared with a second endpoint device, with profile information associated with the sending endpoint device. The salt is “dynamic” by incorporating profile information specific to the sending endpoint device, e.g., one or more of hardware profile information, software profile information, operating system profile information, or network profiling information associated with endpoint device. The profile information may be session specific and/or may change overtime.

In the embodiment, the processing device may further generate a digest via a hash, using the dynamic salt, of a previous message sent to the second endpoint device. In this way, the authentication may include a hash of data already shared between the two endpoint devices. The processing device may further calculate parity information associated with plaintext data. The processing device may further generate a ciphertext data that is verifiable by the second endpoint device via encryption, using a stream cipher, of a combination of the plaintext data, the parity information, and the digest. The communication interface may then transmit the ciphertext data to the second endpoint device.

In another embodiment, a receiving endpoint device includes a processing device and a memory coupled to the processing device. The processing device may generate a dynamic salt via combination of a secret, shared with a first endpoint device, with profile information associated with the first endpoint device. For example, the dynamic salt may be identical to the dynamic salt used to secure data by the sending endpoint device. The processing device may further generate a digest via a hash, using the enhanced salt, of a previous message received from the first endpoint device. The processing device may further decrypt, using a stream cipher to generate enhanced plaintext data, ciphertext data received from the first endpoint device. The processing device may further determine plaintext data via removal of the digest from the enhanced plaintext data. The processing device may further authenticate the plaintext data via verification that parity information concatenated with the plaintext data matches a parity (or parity information) of the plaintext data. The processing device may then one of buffer or store the plaintext data in the memory, e.g., in response to the parity check passing the verification test.

A system for mutual secure communication may include the sending endpoint device (which may be the first endpoint device) and the receiving endpoint device (which may be the second endpoint device). Such a system uses significantly less processor cycles, draws less power, and avoids administration problems faced by current cryptography that uses asymmetric, symmetric, and hash functions. These functions may be employed in disclosed embodiments as will be explained. Additional advantages apparent to those skilled in the art of cybersecurity will be apparent in view of the following more detailed description.

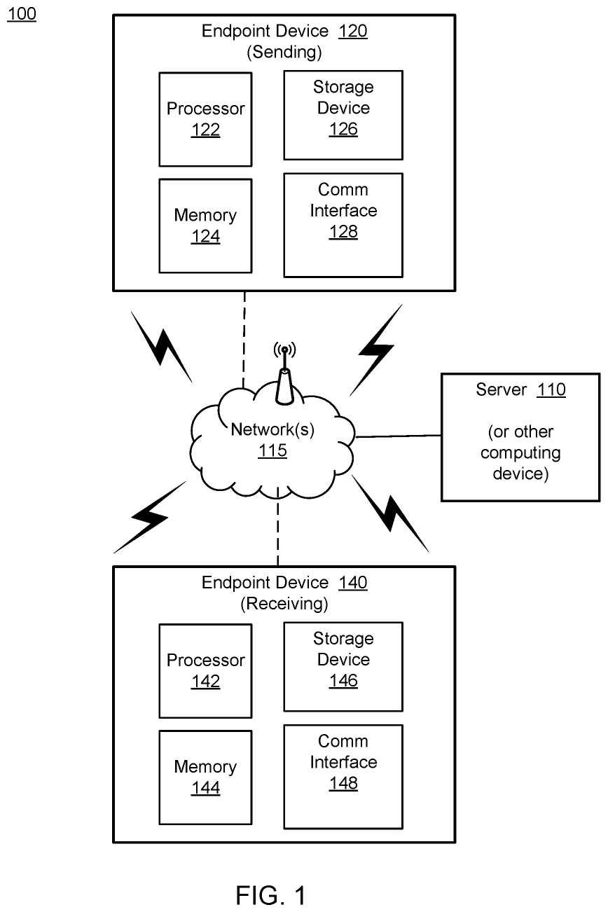

FIG. 1 is a block diagram of a distributed system 100 of a sending endpoint device 120 and a receiving endpoint device 140 according to an embodiment. The sending endpoint device 120 may communicate with the receiving endpoint device 140 over one or more networks 115, which may include one or a combination of local area networks (LAN), wide area network (WAN), personal area network (PAN), and the internet. While the sending and receiving endpoint devices may be generally understood to be intelligent devices such as IoT devices, the sending endpoint device 120 may send data to a server 110 in some embodiments while the receiving endpoint device 140 may receive data from the server 110 in other embodiments. The server 110 may also represent another networked computing device that is other than an endpoint or lightweight device.

In various embodiments, the sending endpoint device 120 includes a processor 122 (e.g., a processing device), a memory 124, a storage device 126, and a communication interface 128. In various embodiments, the receiving endpoint device 140 includes a processor 142 (e.g., processing device), a memory 144, a storage device 146, or a communication interface. The memory 124 and 144 may include a dual in-line memory module (DIMM), a small outline DIMM (SO-DIMM), and/or a non-volatile dual in-line memory module (NVDIMM) or other volatile memory. The storage devices 126 and 146 may be a storage device such as a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Other computer storage and/or storage devices are envisioned. Instructions for execution of the disclosed embodiments may be stored in the storage devices 126 and 146, and executed out of the memory 124 and 114, respectively. In some places herein, the term memory may be referring to the memory and storage devices jointly.

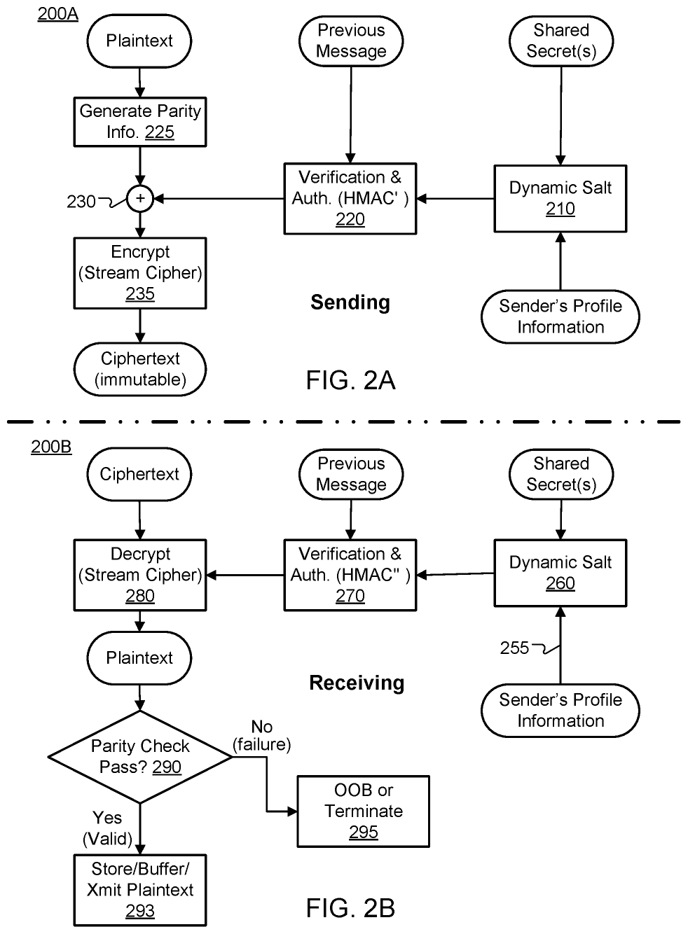

FIG. 2A is a data flow diagram that illustrates a cryptographic process 200A for preparing a plaintext for encrypted transmission in which the plaintext can be verified as non-repudiable and be authenticated as originating from the sender according to some embodiment. In embodiments, the sender makes reference to the sending endpoint device 120 and the receiver makes reference to the receiving endpoint device 140 (FIG. 1).

The process 200A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200A is performed by the sending endpoint device 120 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

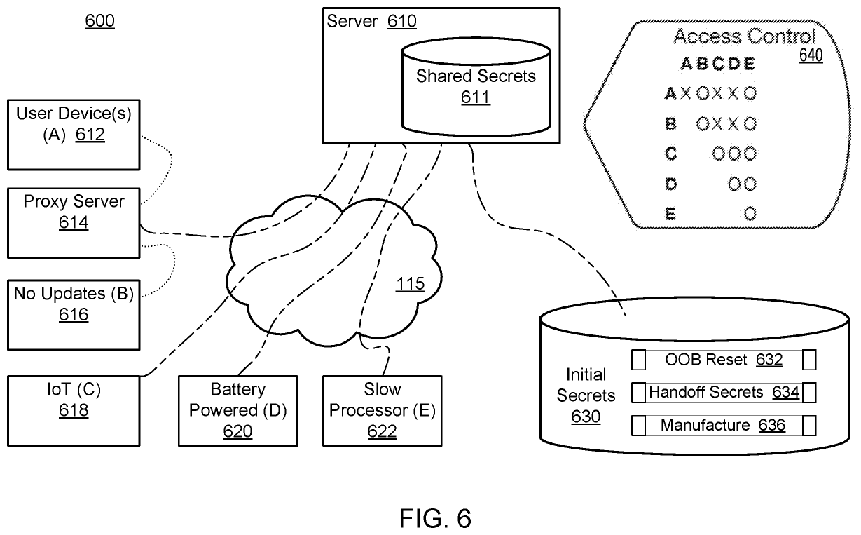

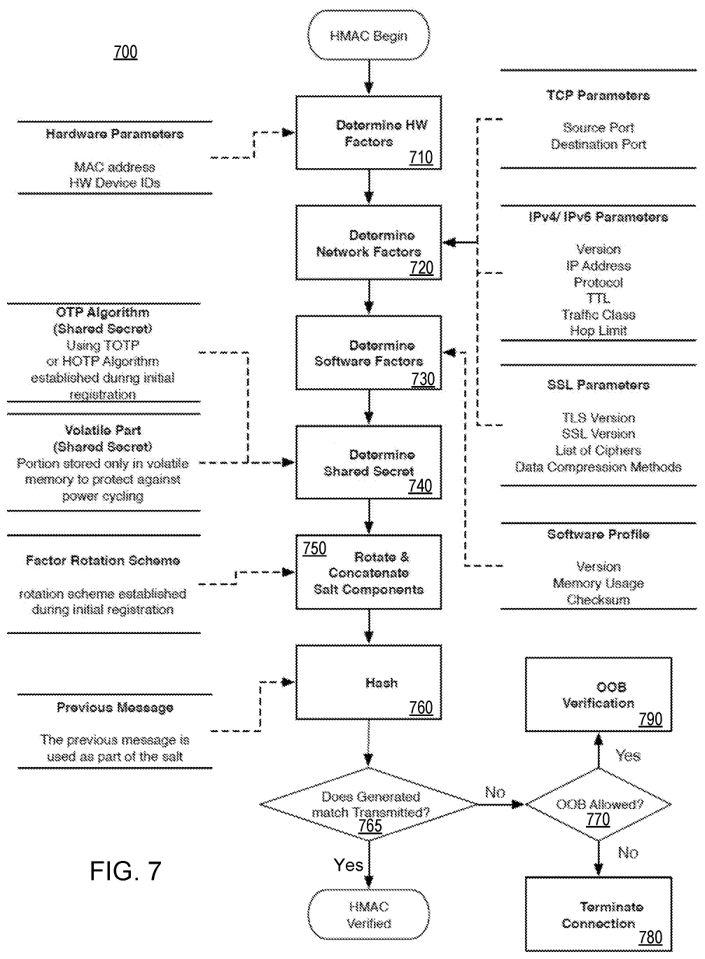

With reference to FIG. 2A, at operation 210, the processing logic creates a dynamic salt that is composed of one or more shared secrets and at least one other factor, such as, for example, profile information of the sender. This profile information may include one or more of hardware profile information, software profile information, operating system profile information, or network profiling information, and be decided on previously between the sending and receiving endpoint devices. For more information about salt composition and generation, see FIG. 7 and accompanying text. The one or more shared secrets may be received, over the communication interface 128, from a third party server, as will be discussed in more detail with reference to FIG. 6.

At operation 220, the processing logic generates a digest by taking a cryptographic hash function (e.g., “hash”) of the previous message using the dynamic salt. The previous message may be the previous network packet exchanged with the receiving endpoint device 140 (or the server 110 in the case of an other-than-endpoint device). The digest may be a hash-based message authentication code, e.g., HMAC′. The cryptographic hash function can be any one-way hash function that returns a result that is sufficiently random, e.g., a result that is at least 128 bits in length.

At operation 225, the processing logic generates parity information based on the plaintext data, e.g., numbers of zeros, numbers of ones, or the like. The parity information may be concatenated to the plaintext data, generating enhanced plaintext data. At operation 230, the processing logic (e.g., summer, exclusive OR (XOR) operator, or the like) may combine the digest with the enhanced plaintext data to generate combined plaintext data. At operation 235, the processing logic may generate, using a stream cipher, ciphertext data (that is verifiable by the second endpoint device) via encryption of a combination of the plaintext data, the parity information, and the digest (e.g., encryption of the combined plaintext data). The result is a ciphertext that is immutable (e.g., unchanging over time or unchangeable), as can be understood by examining the process described by FIG. 2B and the accompanying text.

FIG. 2B is a data flow diagram that illustrates a cryptographic process 200B for decrypting the cipher-text generated in FIG. 2A (or other computing device) for encrypted transmission where the plaintext can be verified as non-repudiable and be authenticated as originating from the sender according to some embodiments. In embodiments, the sender makes reference to the sending endpoint device 120 and the receiver makes reference to the receiving endpoint device 140 (FIG. 1).

The process 200B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200B is performed by the receiving endpoint device 140 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

With reference to FIG. 2B, at operation 255, the processing logic retrieves (or otherwise obtains) the sender's profile information, e.g., dynamically in real time. Because the sender's profile information may be obtained in real time, the profile information may change and is therefore more difficult to spoof by an attacker. This profile information may include one or more of hardware profile information, software profile information, operating system profile information, or network profiling information.

At operation 260, a salt may be concatenated that includes the profile information from the sender along with one or more shared secrets, to generate a dynamic salt. In one embodiment, the dynamic salt is identical to the dynamic salt generated by the sending endpoint device 120 that went into generation of the ciphertext data (FIG. 2A). The one or more shared secrets may be received, over the communication interface 128, from a third party server, as will be discussed in more detail with reference to FIG. 6. The sending and receiving devices may have previously determined which profiling information will be used, and how the different portions of the salt will be ordered. The sending and receiving devices may also have previously determined how to rotate the order of composition of the dynamic salt. For more information about salt composition, see FIG. 7 and accompanying text.

At operation 270, the processing logic generates a digest via a hash, using the dynamic salt, of a previous message received from the first endpoint device. The hash may be the identical cryptographic hash function used to determine the hash (e.g., HMAC′) referenced at operation 210 in FIG. 2A. In one embodiment, the digest that is generated is also a hash-based authentication code (e.g., HMAC″) of the previous message using the dynamic salt.

At operation 280, the processing logic decrypts, using the stream cipher to generate enhanced plaintext data, ciphertext data received from the first endpoint device. The stream cipher may be the same algorithm used to encrypt the plaintext data at operation 235 of FIG. 2A. At operation 290, the processing logic reads the parity information in the enhanced plaintext data and determines whether the parity information passes a parity check associate with the plaintext data.

In some embodiments, if the parity check passes, it means the plaintext data is valid. In this case, at operation 293, the processing logic may store, buffer, or further transmit the plaintext data. Passing the parity check may indicate that the shared secret is known by the sending endpoint device and that the profiling information emitted by the sending endpoint device is correct. The message is therefore authentic and verified as non-repudiable.

If the parity check does not pass, at operation 295, the authentication, verification, and decryption process may end in an out-of-bounds (OOB) error or otherwise terminate its process. The failure to authenticate and verify and subsequent OOB error or termination protects the receiving endpoint device and the one or more network(s) 115 from attackers.

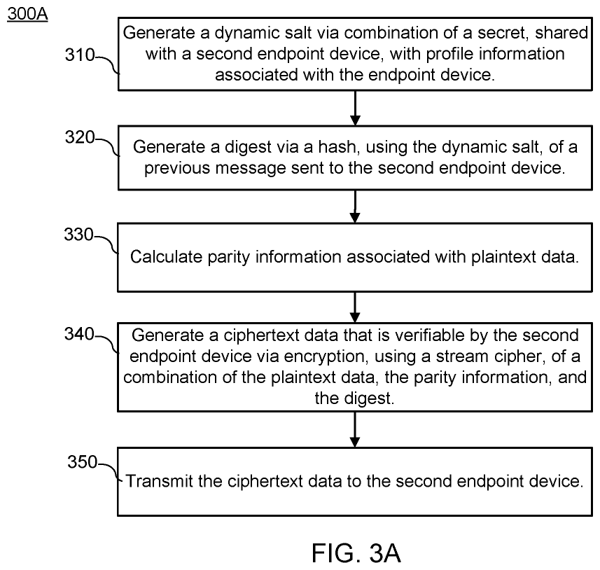

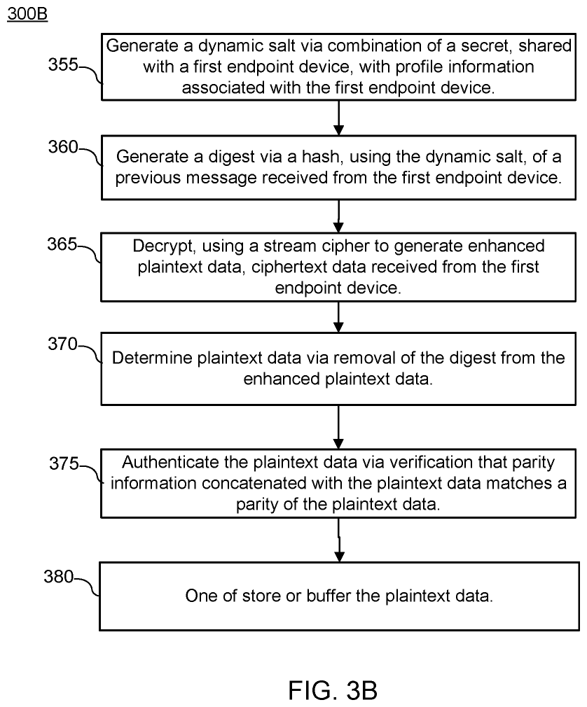

FIG. 3A is a flow chart of a method 300A corresponding to the flow diagram of FIG. 2A according to an embodiment. The method 300A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300A is performed by the sending endpoint device 120 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

With reference to FIG. 3A, at operation 310, the processing logic generates a dynamic salt via combination of a secret, shared with a second endpoint device, with profile information associated with the sending endpoint device. At operation 320, the processing logic generates a digest via a hash, using the dynamic salt, of a previous message sent to the second endpoint device. The hash may be a cryptographic hash function, and the digest may be a hash-based message authentication code. The dynamic salt may include profile information, associated with the sending endpoint device, e.g., one or more of hardware profile information, software profile information, operating system profile information, or network profiling information associated with endpoint device.

At operation 330, the processing logic calculates parity information associated with plaintext data. The parity information may be a numbers of zeros, numbers of ones, a combination thereof, or the like.

At operation 340, the processing logic generates, using a stream cipher, ciphertext data (that is verifiable by the second endpoint device) via encryption of a combination of the plaintext data, the parity information, and the digest. In some embodiments, the stream cipher is the digest generated at operation 320.

In one embodiment, as a sub-process of operation 340, the processing logic generates enhanced plaintext data via concatenation of the parity information with the plaintext data. The processing logic further generates combined plaintext data that is to be encrypted with the stream cipher via combination of the enhanced plaintext data with the digest using an exclusive OR (XOR) function. At operation 350, the processing logic transmits the ciphertext data to the second endpoint device 140 (or the server 110).

FIG. 3B is a flow chart of a method 300B corresponding to the flow diagram of FIG. 2B according to an embodiment. The method 300B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300B is performed by the receiving endpoint device 140 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

With reference to FIG. 3B, at operation 355, the processing logic generates a dynamic salt via combination of a secret, shared with a first endpoint device, with profile information associated with the first endpoint device. In one embodiment, the first endpoint device may be understood as the sending endpoint device 120 (FIG. 1). The dynamic salt may be the same used by the first endpoint device due to the first endpoint device using the same shared secret and same profile information, which was transmitted to the receiving endpoint device 140.

At operation 360, the processing logic generates a digest via a hash, using the dynamic salt, of a previous message received from the first endpoint device. In embodiments, the hash is a cryptographic hash function, and the digest is a hash-based message authentication code, e.g., HMAC″.

At operation 365, the processing logic decrypts, using a stream cipher to generate enhanced plaintext data, ciphertext data received from the first endpoint device. The plaintext data is enhanced because it still contains the digest. In one embodiment, the stream cipher is the digest generated at operation 360.

At operation 370, the processing device determines plaintext data via removal of the digest from the enhanced plaintext data. At operation 375, the processing logic authenticates the plaintext data via verification that parity information concatenated with the plaintext data matches a parity of the plaintext data. The parity information and checking was discussed previously. At operation 380, the processing logic one of stores or buffers (and/or may further transmit) the plaintext data in response to successfully passing the parity check.

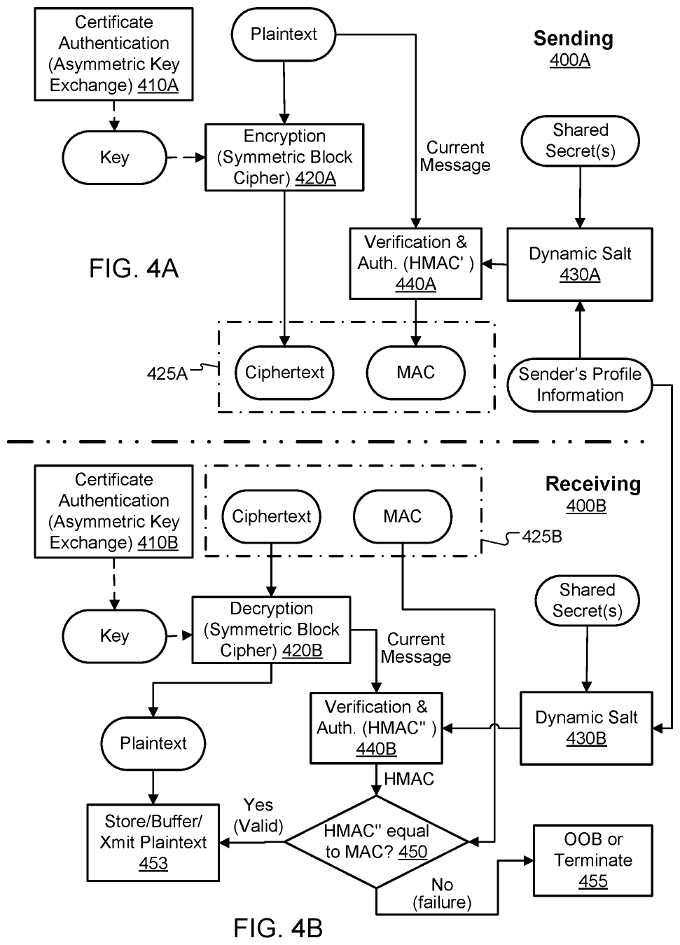

FIG. 4A is a data flow diagram that illustrates another cryptographic process 400A for encrypting plaintext that combines public key infrastructure (PKI) with a method for authentication and verification according to some embodiment. In embodiments, the sender makes reference to the sending endpoint device 120 and the receiver makes reference to the receiving endpoint device 140 (FIG. 1). The cryptographic process 400A may integrate a combination of the process 200A with PKI cipher suites, e.g., to supplement existing standard PKI, making it more secure. Alternately, the disclosed verification and authentication can be employed on computing devices that have such small processing power or battery power that they cannot employ standard PKI methods.

The process 400A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400A is performed by the sending endpoint device 120 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

With reference to FIG. 4A, at operation 410A, the processing logic determines a key via asymmetric key exchange with a third party server. The asymmetric key exchange may include certificate authentication of a PKI certificate as part of the asymmetric key exchange.

At operation 420A, the processing logic generates ciphertext data via encryption of the plaintext data using the key with a symmetric block cipher. This embodiment may be performed without using a stream cipher, so the current message (rather than the previous message) can be the subject of the hash function. The encryption may instead be performed by a symmetric block cipher such as provided by the certificate authentication performed at operation 410A, and thus generate ciphertext.

At operation 430A, the processing logic generates a dynamic salt via combination of a secret, shared with a second endpoint device, with profile information associated with the sending endpoint device. See also operation 210 (FIG. 2A). At operation 440A, the processing logic generates a message authentication code (MAC) via a hash, using the dynamic salt, of plaintext data of a current message to be sent to the second endpoint device. In one embodiment, the hash is a cryptographic hash function, and the MAC is a hash-based message authentication code (HMAC′).

At operation 425A, the processing logic sends the current message that includes the ciphertext data and the MAC, e.g., to the second endpoint device, which may be the receiving endpoint device 140 in one embodiment.

FIG. 4B illustrates a data flow diagram that illustrates another cryptographic process 400B for decrypting plaintext generated in FIG. 4A that combines public key infrastructure (PKI) with a method for authentication and verification according to some embodiments. In embodiments, the sender makes reference to the sending endpoint device 120 and the receiver makes reference to the receiving endpoint device 140 (FIG. 1). The cryptographic process 400B may integrate a combination of the process 200B with PKI cipher suites, e.g., to supplement existing standard PKI, making it more secure. Alternately, the disclosed verification and authentication can be employed on computing devices that have such small processing power or battery power that they cannot employ standard PKI methods.

The process 400B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400B is performed by the receiving endpoint device 140 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

With reference to FIG. 2B, at operation 42B, the processing logic may receive a message authentication code (MAC) concatenated to a ciphertext data in a current message received from a first endpoint device, e.g., the sending endpoint device 120 or the server 110 (or other computing device).

At operation 410B, the processing logic determines a key via asymmetric key exchange with a third party server. The asymmetric key exchange may include certificate authentication of a PKI certificate as part of the asymmetric key exchange. At operation 420B, the processing logic generates plaintext data via decryption of the ciphertext data using the key with a symmetric block cipher.

At operation 430A, the processing logic generates a dynamic salt via combination of a secret, shared with the first endpoint device, with profile information associated with the sending endpoint device. In one embodiment, the dynamic salt is identical to the dynamic salt generated by the sending endpoint device 120 that went into generation of the ciphertext data (FIG. 4A). The one or more shared secrets may be received, over the communication interface 128, from a third party server, as will be discussed in more detail with reference to FIG. 6. The sending and receiving devices may have previously determined which profiling information will be used, and how the different portions of the salt will be ordered. The sending and receiving devices may also have previously determined how to rotate the order of composition of the dynamic salt. For more information about salt composition, see FIG. 7 and accompanying text.

At operation 440B, the processing logic generates a digest via a hash, using the dynamic salt, of plaintext data generated at operation 420B. In one embodiment, the hash is a cryptographic hash function, and the hash is a hash-based message authentication code (HMAC″).

At operation 450, the processing logic determines whether the HMAC″ matches the MAC that was received in the current message from the first endpoint device. If there is a match, at operation 453, the processing logic may one of store, buffer, or transmit the plaintext data. The matching of the HMAC″ with the MAC may indicate that the ciphertext received is valid and non-repudiable. If the HMAC″ does not match the MAC, at operation 455, the processing logic may indicate the communication as OOB (e.g., generate an OOB error) and/or terminate the data exchange between the two devices, e.g., the sending endpoint device and the receiving endpoint device.

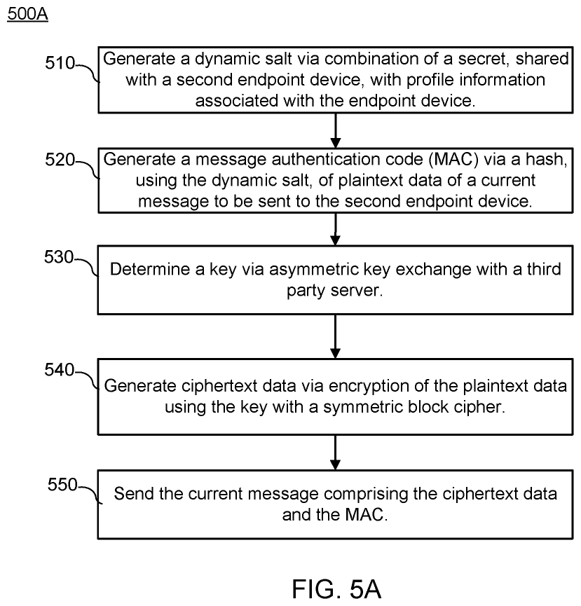

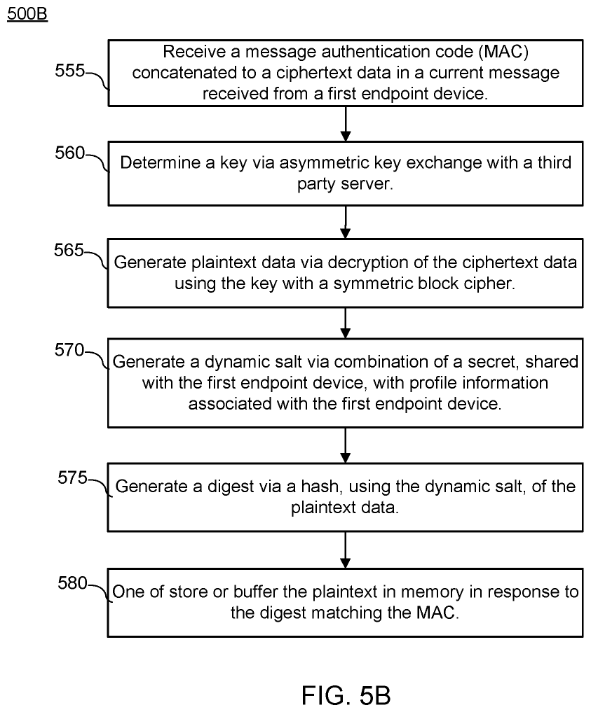

FIG. 5A is a flow chart of a method 500A corresponding to the flow diagram of FIG. 4A according to an embodiment. The method 500A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500A is performed by the sending endpoint device 120 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

With reference to FIG. 5A, at operation 510, the processing logic generates a dynamic salt via combination of a secret, shared with a second endpoint device, with profile information associated with the endpoint device, e.g., with the sending endpoint device. The profile information may include one or more of hardware profile information, software profile information, operating system profile information, or network profiling information associated with sending endpoint device. The processing logic may further receive the secret from a third party server, e.g., that contains a database of shared secrets.

At operation 520, the processing logic generates a message authentication code (MAC) via a hash, using the dynamic salt, of plaintext data of a current message to be sent to the second endpoint device. The current message may be, for example, a current network packet to be sent out by the sending endpoint device. In one embodiment, the hash is a cryptographic hash function, and the MAC is a hash-based message authentication code (HMAC′).

At operation 530, the processing logic determines a key via asymmetric key exchange with a third party server. In one embodiment, the processing logic is to authenticate the key using certificate authentication of a public key infrastructure (PKI) certificate. At operation 540, the processing logic generates ciphertext data via encryption of the plaintext data using the key with a symmetric block cipher. At operation 550, the processing logic sends the current message, which includes the ciphertext data and the MAC, to the second endpoint device, which may be the receiving endpoint device (FIG. 5B) in one embodiment.

FIG. 5B is a flow chart of a method 500B corresponding to the flow diagram of FIG. 5A according to an embodiment. The method 500B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500B is performed by the receiving endpoint device 140 (FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

With reference to FIG. 5B, at operation 555, the processing logic receives a message authentication code (MAC) concatenated to a ciphertext data in a current message received from a first endpoint device. In one embodiment, the first endpoint device is the sending endpoint device 120 (FIG. 5A).

At operation 560, the processing logic determines a key via asymmetric key exchange with a third party server. In one embodiment, the processing logic is to authenticate the key using certificate authentication of a public key infrastructure (PKI) certificate.

At operation 565, the processing device generates plaintext data via decryption of the ciphertext data using the key with a symmetric block cipher. At operation 570, the processing device generates a dynamic salt via combination of a secret, shared with the first endpoint device, with profile information associated with the first endpoint device. The profile information may include one or more of hardware profile information, software profile information, operating system profile information, or network profiling information associated with sending endpoint device. The processing logic may further receive the secret from a third party server, e.g., that contains a database of shared secrets.

At operation 575, the processing logic generates a digest via a hash, using the dynamic salt, of the plaintext data. The hash may be a cryptographic hash function, and the digest may be a hash-based message authentication code (e.g., HMAC″).

At operation 580, the processing logic one of stores or buffers the plaintext in memory in response to the digest matching the MAC. In the case the digest does not match the MAC, the processing logic may one of terminate communication with the first endpoint device or indicate the communication as out of bounds (OOB) in response to the digest not matching the MAC.

FIG. 6 is a network architecture diagram 600 that illustrates various computing endpoints communicating with a server 610 using shared secrets according to various embodiments. The shared secrets may be stored in a shared secrets database 611 of the server 610. The shared secrets can be used to effectuate access control and can be shared initially through multiple processes. In various embodiments, the computing endpoint devices can be any kind of computing endpoint, such as, for example, IoT devices 618, battery powered IoT devices 620, and IoT devices with slow processors 622. An access control data structure 640 may cross index shared secrets with various computing endpoint devices as illustrated in FIG. 6 (note the letter indications applied to certain ones of the computing endpoint devices).

In various embodiments, some computing endpoints 616 may not have their software updated, or, are under the control of user devices 612 without the power to update their software. These non-updated devices may connect through a proxy server 614. Server 610 may keep the database 611 of shared secrets for all of the endpoint devices being tracked in the one or more network(s) 115. The initial shared secrets 630 can be established by an out of bounds (OOB) reset 632, through a secure handoff process 634 that happens over the network(s) 115, or may be set at the time of deployment by a manufacturer 636. The server 610 can use the list of shared secrets to maintain access control records to conform with security policies stored in the access control database 650.

In one embodiment, the manufacturer-set key (usable for identification to request the shared secrets) may be a trusted platform module (TPM) generated key of the endpoint device. A TPM generated key may be generated by a specialized chip on an endpoint device that stores RSA encryption keys specific to the host system for hardware authentication. Each TPM chip contains an RSA key pair called the Endorsement Key (EK). The key pair may be maintained inside the chip and cannot be accessed by software. A Storage Root Key (SRK) is created when a user or administrator takes ownership of the system. This key pair is generated by the TPM based on the Endorsement Key and an owner-specified password.

FIG. 7 is a data flow diagram 700 that illustrates a process of composing a salt for a cryptographic hash function using components from the sending devices hardware, software, previous message, and shared secrets according to various embodiments. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the sending endpoint device 120 (FIG. 1).

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In various embodiments, the dynamic salt is composed of different factors, e.g., pieces of profile information, including but not limited to, hardware (HW) profile information, software (SW) profile information, operating system profile information, and/or network profiling information associated with the endpoint device. With reference to

FIG. 7, at operation 710, the processing logic may determine hardware factors that may be used within the hardware profile information, such a MAC address and hardware device identifiers (IDs).

At operation 720, the processing logic may determine network factors that may be used with the network profile information. These network factors may include, for example, Transport Control Protocol (TCP) information such as source port and/or destination port. The network factors may further include Internet Protocol (IP) version four or version six (e.g., IPv4 or IPv6) parameters, such as version, IOP address, protocol type, TTL security mechanism, traffic class, hop limit, and the like. The network factors may further include Secure Socket Layer (SSL) parameters such as Transport Layer Security (TLS) version, SSL version, list of ciphers, data compression methods, and the like.

At operation 730, the processing logic may determine software factors that may be used with the software profile information. The software factors may include, for example, version, memory usage, and/or checksum information.

At operation 740, the processing logic may determine a shared secret to be used within the dynamic salt. The shared secret may be generated, for example, via a one-time algorithm such as the Time-based One-time Password (TOTP) algorithm or the HMAC-based One-time Password (HOTP) algorithm established during initial registration. The HOTP algorithm is a one-time password (OTP) algorithm based on hash-based message authentication codes (HMAC) and is a cornerstone of the Initiative for Open Authentication (OATH). The TOTP algorithm is an extension of the HOTP algorithm generating a one-time password by instead taking uniqueness from the current time. The TOTP algorithm has been adopted as Internet Engineering Task Force standard RFC 6238, is the cornerstone of OATH, and is used in a number of two-factor authentication systems. Furthermore, a volatile part of the shared secret may be a portion stored only in volatile memory to protect against power cycling.

At operation 750, the processing logic may rotate and concatenate salt components according to a factor rotation scheme established during initial registration. When the sending endpoint device 120 and the receiving endpoint device 140 (or other computing device, such as the server 110) establish their shared secrets, these endpoint devices can also establish a scheme (or schedule) for rotation of the various parameters that make up the dynamic salt. The scheme may integrate aspects of rotation, concatenation, and/or inclusion of salt components in different embodiments.

At operation 760, the processing logic make take a hash of a previous message (e.g., a message already exchanged between the endpoint devices, and thus a message that would have already been sent or received by the sending endpoint device). At operation 765, the processing logic may determine whether the generated hash value(s) matches the transmitted (e.g., received) hash value(s). If the answer is yes, the HMAC is verified and the receiving endpoint device 140 may safely use or further transmit the data, e.g., that has been decrypted as discussed with reference to FIG. 3B and FIG. 5B. If the answer is no, at operation 770, the processing logic may determine whether OOB communication is allowed. If OOB communication is not allowed, at operation 780, the processing logic terminates the communication connection between the endpoint devices (or performs some other predetermined remedial measure that triggers a need for the endpoint devices to mutually authenticate). If OOB communication is allowed, at operation 790, the OOB may be verified before allowing the OOB communication to continue.

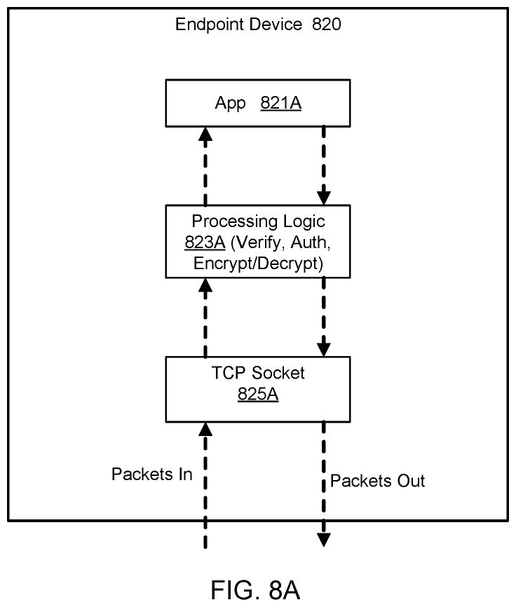

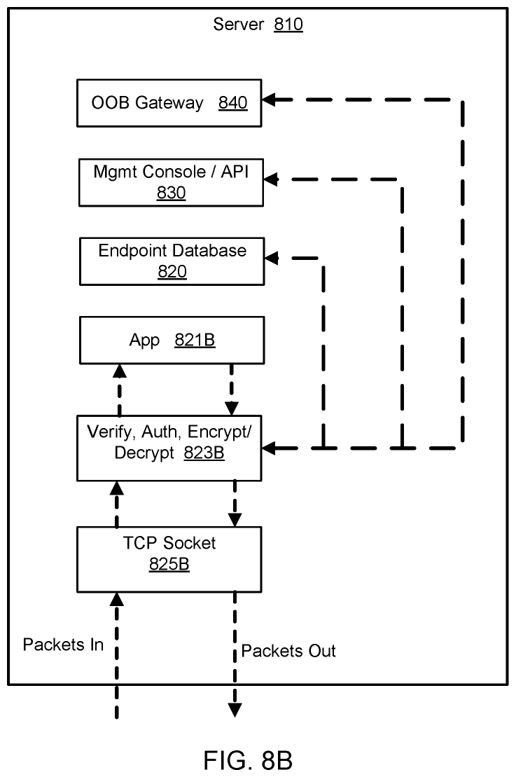

FIG. 8A is a deployment diagram for an endpoint device 820 according to an embodiment. The endpoint device 820 may include an application 821A (e.g., executing on a processor or processing device thereof), processing logic 823A to support verification, authentication, and encryption/decryption of network packets, and a TCP socket 825A coupled to the processing logic 823A. The TCP socket 825A may handle the receiving and transmitting of the network packets on behalf of the endpoint device 820.

FIG. 8B illustrates a deployment diagram for a server 810 that manages endpoints and out-of-bound (OOB) communications according to some embodiments. The server 810 may include an OOB gateway 840, a management console 830, which may also include an application programming interface (API), an endpoint database 820, an application 821B (e.g., executing on a processing or processing device), processing logic 823B to support verification, authentication, and encryption/decryption of network packets, and a TCP socket 825A coupled to the processing logic. The TCP socket 825B may handle the receiving and transmitting of the network packets on behalf of the server 810.

In various embodiments, the processing logic 823B may be coupled to the OOB gateway 840, the management console 830, and the endpoint database 820. The OOB gateway 840 may perform the OOB checks in terms of determining whether digests match and what action to take in response to a mismatch of digests, e.g., cryptographic hashes determined as described herein. The endpoint database 820 may be adapted to provide secure storage for the server 810 and store shared secrets and profile information for the endpoint device 820 (FIG. 8A). In one embodiment, the server 810 is identical to the server 610 of FIG. 6.

In one embodiment, a system is disclosed for efficiently encrypting, authenticating, and verifying the exchange of data between two endpoints. In various embodiments, the system includes a sending computing device and a receiving computing device, wherein the computing devices have securely exchanged at least one previous message and wherein the computing devices each have a preexisting shared secret. The sending computing device may send a message via a secure transmission to the receiving device, wherein the sending computing device is adapted to: concatenate, independently of the receiving device, a first salt by linking together the shared secret and at least one factor selected from the group including: a hardware profile of the sending computing device, an operating system profile of the sending computing device, a firmware profile the sending computing device, and/or a software profile of the sending computing device. The sending computing device may further cryptographically determine a first digest by hashing the previous message using the first salt. The sending computing device may further calculate parity information for the message (e.g., a number of ones or zeros or the like) and append the parity information to the message. The sending computing device may further encrypt the message (combined with the first digest and the parity information), e.g., by employing the first digest as a stream cipher. The sending computing device may further transmit the ciphertext to the receiving device.

In various embodiments, the receiving computing device is adapted to concatenate, independently of the sending device, a second salt (which may be the same or different than the first salt) by linking together the shared secret and at least one factor selected from the group comprising a hardware profile of sending computing device, an operating system profile of the sending computing device, a firmware profile of the sending computing device, and/or a software profile of the sending computing device. The receiving computing device may further cryptographically determine a second digest by hashing the previous message using the second salt and receiving the ciphertext from the sending device. The receiving computing device may further decrypt the second digest from the ciphertext by reversing the stream cipher on the second digest, and thus generate plaintext of the original message. The receiving computing device may further check the integrity of the plaintext using the parity information. The receiving computing device may further compare the first digest and the second digest, whereby if they are identical, then the system has verified the authenticity and integrity of the message.

While certain examples are described herein, the approach discussed can be configured to use any number of system identification algorithms or cost metrics to predict and evaluate performance prediction. Possible algorithms include support vector machines, deep neural networks, various regressions, decision trees, and supervised learning variants.

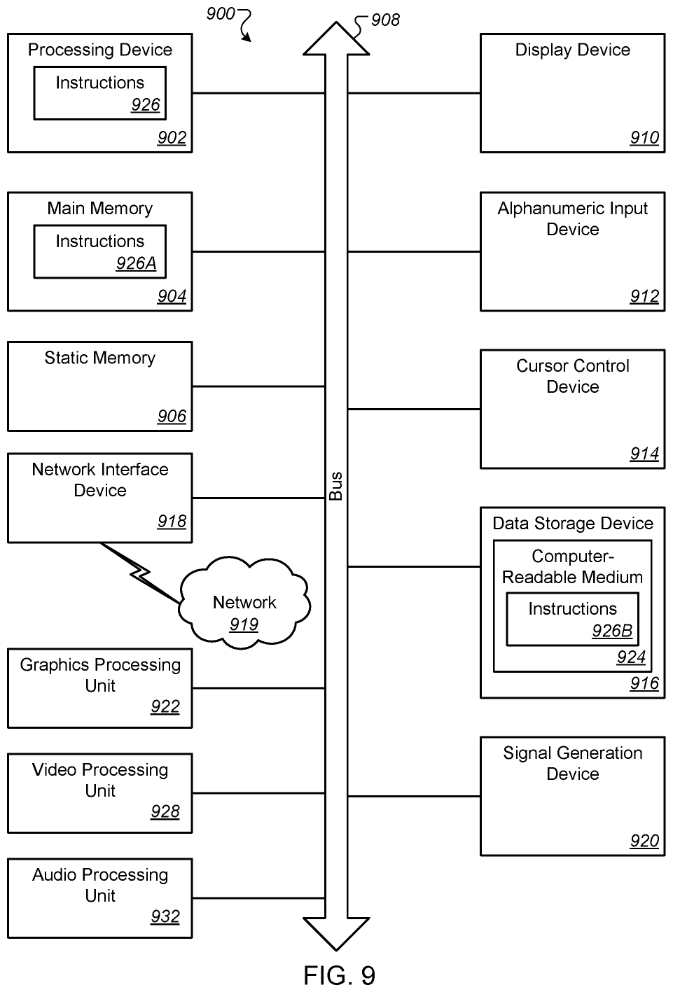

FIG. 9 is a block diagram for a computing system 900 (or machine) according to various embodiments of any of the communication devices disclosed herein, with particular emphasis on endpoint devices such as IoT devices, and servers or other network-facilitative computing devices. In alternative embodiments, the computing system 900 may be connected (e.g., networked) to other machines in a LAN, an intranet, an extranet, or the Internet. The computing system 900 may operate in the capacity of a server or a client device in a client-server network environment, or as a peer machine in a peer-to-peer (or distributed) network environment. The computing system 900 may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computing system 900 includes a processing device 902, main memory 904 (e.g., flash memory, dynamic random access memory (DRAM) (such as synchronous DRAM (SDRAM) or DRAM (RDRAM), etc.), a static memory 906 (e.g., flash memory, static random access memory (SRAM), etc.), and a data storage device 916, which communicate with each other via a bus 908.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application-specific integrated circuit (ASIC), a field programmable gate array (FPGA), a digital signal processor (DSP), network processor, or the like. In one embodiment, processing device 902 may include one or more processor cores. The processing device 902 is configured to execute the processing logic 926 for performing the operations discussed herein.

In one embodiment, processing device 902 can be part of a processor or an integrated circuit that includes the disclosed security applications. Alternatively, the computing system 900 can include other components as described herein.

The computing system 900 may further include a network interface device 918 communicably coupled to a network 919. The computing system 900 also may include a video display device 910 (e.g., a liquid crystal display (LCD) or a cathode ray tube (CRT)), an alphanumeric input device 912 (e.g., a keyboard), a cursor control device 914 (e.g., a mouse), a signal generation device 920 (e.g., a speaker), or other peripheral devices. Furthermore, computing system 900 may include a graphics processing unit 922, a video processing unit 928 and an audio processing unit 932. In another embodiment, the computing system 900 may include a chipset (not illustrated), which refers to a group of integrated circuits, or chips, that are designed to work with the processing device 902 and controls communications between the processing device 902 and external devices. For example, the chipset may be a set of chips on a motherboard that links the processing device 902 to very high-speed devices, such as main memory 904 and graphic controllers, as well as linking the processing device 902 to lower-speed peripheral buses of peripherals, such as USB, PCI or ISA buses.

The data storage device 916 may include a non-transitory computer-readable storage medium 924 on which is stored software 926A embodying any one or more of the methodologies of functions described herein. The software 926A may also reside, completely or at least partially, within the main memory 904 as instructions and/or within the processing device 902 as processing logic 926 during execution thereof by the computing system 900; the main memory 904 and the processing device 902 also constituting computer-readable storage media.

The computer-readable storage medium 924 may also be used to store instructions 926B utilizing the processing device 902, and/or a software library containing methods that call the above applications. While the computer-readable storage medium 924 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the disclosed embodiments. The term “computer-readable storage medium” shall accordingly be taken to include, but not be limited to, solid-state memories, and optical and magnetic media.

While the disclosure has been described with respect to a limited number of embodiments, those skilled in the art will appreciate numerous modifications and variations therefrom. It is intended that the appended claims cover all such modifications and variations as fall within the true spirit and scope of this disclosure.

In the description herein, numerous specific details are set forth, such as examples of specific types of hardware and system configurations, specific hardware structures, specific instruction types, specific system components, and operation in order to provide a thorough understanding of the disclosure. It will be apparent, however, to one skilled in the art that these specific details need not be employed to practice the disclosure. In other instances, well known components or methods, such as specific and alternative hardware or software architectures, specific logic circuits/code for described algorithms, specific firmware code, specific interconnect operation, specific logic configurations, specific manufacturing techniques and materials, specific expression of algorithms in code, specific power down techniques/logic and other specific operational details of a computer system have not been described in detail in order to avoid unnecessarily obscuring the disclosure.

The embodiments are described with reference to mutual authentication of communication devices, such as in computing platforms or microprocessors. The embodiments may also be applicable to other types of integrated circuits and programmable logic devices. For example, the disclosed embodiments are not limited to desktop computer systems or portable computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. Moreover, the apparatuses, methods, and systems described herein are not limited to physical computing devices, but may also relate to software optimizations for energy conservation and efficiency.

Although the above examples describe instruction handling and distribution in the context of execution units and logic circuits, other embodiments of the disclosure can be accomplished by way of a data or instructions stored on a machine-readable, tangible medium, which when performed by a machine cause the machine to perform functions consistent with at least one embodiment of the disclosure. In one embodiment, functions associated with embodiments of the disclosure are embodied in machine-executable instructions. The instructions can be used to cause a general-purpose or special-purpose processor that is programmed with the instructions to perform the steps of the disclosure. Embodiments of the disclosure may be provided as a computer program product or software which may include a machine or computer-readable medium having stored thereon instructions which may be used to program a computer (or other electronic devices) to perform one or more operations according to embodiments of the disclosure. Alternatively, operations of embodiments of the disclosure might be performed by specific hardware components that contain fixed-function logic for performing the operations, or by any combination of programmed computer components and fixed-function hardware components.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and/or ‘operable to,’ in one embodiment, refers to some apparatus, logic, hardware, and/or element designed in such a way to enable use of the apparatus, logic, hardware, and/or element in a specified manner. Note as above that use of ‘to,’ ‘capable to,’ or ‘operable to,’ in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “receiving,” “determining,” “issuing,” “linking,” “associating,” “obtaining,” “authenticating,” “prohibiting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

What is claimed is:

1. An endpoint device comprising:
a processing device to:
generate a dynamic salt via combination of a secret, shared with a second endpoint device, with profile information associated with the endpoint device;
generate a digest via a hash, using the dynamic salt, of a previous message sent to the second endpoint device;
calculate parity information associated with plaintext data; and
generate, using a stream cipher, ciphertext data that is verifiable by the second endpoint device via encryption of a combination of the plaintext data, the parity information, and the digest; and
a communication interface coupled to the processing device, wherein the communication interface is adapted to transmit the ciphertext data to the second endpoint device.

2. The endpoint device of claim 1, wherein the hash comprises a cryptographic hash function, and wherein the digest comprises a hash-based message authentication code.

3. The endpoint device of claim 1, wherein the profile information comprises one or more of hardware profile information, software profile information, operating system profile information, or network profiling information associated with the endpoint device.

4. The endpoint device of claim 1, wherein the processing device is further to:
generate enhanced plaintext data via concatenation of the parity information with the plaintext data; and
generate combined plaintext data that is to be encrypted with the stream cipher via combination of the enhanced plaintext data with the digest using an exclusive OR (XOR) function.

5. The endpoint device of claim 1, wherein the processing device is further to receive, over the communication interface, the secret from a third party server, the third party server comprising a database of shared secrets.

6. The endpoint device of claim 1, wherein the stream cipher is the digest.

7. An endpoint device comprising:
a processing device to:
generate a dynamic salt via combination of a secret, shared with a first endpoint device, with profile information associated with the first endpoint device;
generate a digest via a hash, using the dynamic salt, of a previous message received from the first endpoint device;
decrypt, using a stream cipher to generate enhanced plaintext data, ciphertext data received from the first endpoint device;
determine plaintext data via removal of the digest from the enhanced plaintext data; and
authenticate the plaintext data via verification that parity information concatenated with the plaintext data matches a parity of the plaintext data; and
a memory coupled to the processing device, the memory to one of store or buffer the plaintext data.

8. The endpoint device of claim 7, wherein the hash comprises a cryptographic hash function, and wherein the digest comprises a hash-based message authentication code.

9. The endpoint device of claim 7, further comprising a communication interface coupled to the processing device, the communication interface to receive the profile information and the ciphertext data emitted by the first endpoint device.

10. The endpoint device of claim 7, wherein the profile information comprises one or more of hardware profile information, software profile information, operating system profile information, or network profiling information associated with endpoint device.

11. The endpoint device of claim 7, wherein, to remove the digest from the enhanced plaintext data, the processing device is to perform an exclusive OR (XOR) on the enhanced plaintext data with the digest.

12. The endpoint device of claim 7, wherein, to verify the parity information, the processing device is to:
remove the parity information from the plaintext data;
generate second parity information comprising the parity of the plaintext data; and
determine whether the parity information matches the second parity information.

13. The endpoint device of claim 7, wherein the processing device is further to receive the secret from a third party server, the third party server comprising a database of shared secrets.

14. The endpoint device of claim 7, wherein the stream cipher is the digest.

15. A non-transitory computer-readable storage medium that stores instructions, which when executed by a processing device of an endpoint device, cause the processing device to:
generate a dynamic salt via combination of a secret, shared with a second endpoint device, with profile information associated with the endpoint device;
generate a message authentication code (MAC) via a hash, using the dynamic salt, of plaintext data of a current message to be sent to the second endpoint device;
determine a key via asymmetric key exchange with a third party server;
generate ciphertext data via encryption of the plaintext data using the key with a symmetric block cipher; and
send the current message comprising the ciphertext data and the MAC.

16. The non-transitory computer-readable storage medium of claim 15, wherein the instructions further cause the processing device to authenticate the key using certificate authentication of a public key infrastructure (PKI) certificate.

17. The non-transitory computer-readable storage medium of claim 15, wherein the hash comprises a cryptographic hash function, and wherein the MAC is a hash-based message authentication code (HMAC).

18. The non-transitory computer-readable storage medium of claim 15, wherein the profile information comprises one or more of hardware profile information, software profile information, operating system profile information, or network profiling information associated with the endpoint device.

19. The non-transitory computer-readable storage medium of claim 15, wherein the instructions further cause the processing device to receive the secret from the third party server.

20. A non-transitory computer-readable storage medium that stores instructions, which when executed by a processing device, cause the processing device to:
receive a message authentication code (MAC) concatenated to a ciphertext data in a current message received from a first endpoint device;
determine a key via asymmetric key exchange with a third party server;
generate plaintext data via decryption of the ciphertext data using the key with a symmetric block cipher;
generate a dynamic salt via combination of a secret, shared with the first endpoint device, with profile information associated with the first endpoint device;
generate a digest via a hash, using the dynamic salt, of the plaintext data; and
one of store or buffer the plaintext in memory in response to the digest matching the MAC.

21. The non-transitory computer-readable storage medium of claim 20, wherein the instructions further cause the processing device to one of terminate communication with the first endpoint device or indicate the communication as out of bounds (OOB) in response to the digest not matching the MAC.

22. The non-transitory computer-readable storage medium of claim 20, wherein the hash comprises a cryptographic hash function, and wherein the digest comprises a hash-based message authentication code.

23. The non-transitory computer-readable storage medium of claim 20, wherein the profile information comprises one or more of hardware profile information, software profile information, operating system profile information, or network profiling information associated with an endpoint device that comprises the processing device.

24. The non-transitory computer-readable storage medium of claim 20, wherein the instructions further cause the processing device to receive the secret from the third party server.
